(19) United States
(12) Patent Application Publication
(10) Pub. No.: US 2009/0156279 A1
(43) Pub. Date: Jun. 18, 2009

(54) System and method for competition between teams

(76) Inventor: Victor James MacLaughlin, Richmond, VA (US)

Correspondence Address: VICTOR J. MACLAOGHLIN, 4615 KENSINGTON AVE., RICHMOND, VA, 23226, US

(21) Appl. No.: 12/290,024

(22) Filed: Oct. 24, 2008

Related U.S. Application Data
(60) Provisional application No. 61/000,399, filed on Oct. 24, 2007.

(51) Int. Cl. A63F 9/24; A63F 13/00

(52) U.S. Cl. 463/9; 463/40

(57) ABSTRACT

The invention is a method and system for providing a game in which different teams/companies compete to determine which team/company can generate the most income in a selected period of time, such as one year. Teams are formed of multiple players, with each player providing a player fee in the form of money or other valuable assets (e.g., ideas, expertise, etc.). Multiple teams form the game, which is overseen by a controlling organization. The game may be broadcast, as a television or web-based broadcast, and may include one or more websites to provide information to the public (either free or for a fee) on the overall game and/or individual team developments.

### RELATED PATENT APPLICATIONS

The present application claims priority under 35 U.S.C. Section 119(e) from Provisional Patent Application No. 61/000,399, filed Oct. 24, 2007 and entitled “System and Method for Competition Between Teams.,” the disclosure of which is hereby incorporated by reference herein in its entirety.

### FIELD OF THE INVENTION

The invention relates to games including a team challenge which may be transmitted via web-based and/or television systems.

### BACKGROUND

Reality-based television shows are well known in the art, including such shows where different teams compete against each other for prizes and/or other rewards. The winners of such competitions are often selected via popular vote of the teams/team members and/or the viewers.

### SUMMARY

The invention is a game run by a controlling organization. The invention involves a competition of multiple teams each having multiple members. The invention is designed for outside interaction from guests outside of the game for information and opinion. There may be a number of opportunities for those following the game to vote on the winner of certain challenges via the internet or television (e.g., voting for which team ended up with the best product/good/service or which team has the best marketing plan). Those following the game and interacting have a chance to win prizes for their input and opinions.

For example, in one embodiment, there are 10 teams with each team having 4 players. This embodiment is just one within the scope of the invention, and is set forth by way of example for simplicity of depicting the organization and operation of the game. Almost any number of players or teams would work, depending on the game played.

Each player is a “Board Member” of his/her team and will invest a selected amount (such as $50,000 per player) into the game. The investments from the players are used by the controlling organization to fund the fixed budgets of the teams, the board member bonus, other operational costs of the game, other related expenses, etc. In one embodiment, each team/company will be provided with the same fixed budget as all of the other teams.

The investors/board members may choose the particular goods/services/etc. which their company will provide, and also offer guidance to their companies in order to increase their ability to succeed. These Board Members will interact with a central game office provided by the controlling organization, and will use a fixed budget (which can be the same for each team, such as a $100,000 budget) in order to run their companies/corporations. The organization and layout of the game enable the “game feel.” Each team/corporation may be run from physical and/or virtual offices, but are not necessarily limited to the central game office or another venue to assist with their service/good/production.

In one embodiment of the invention, the winning team will be the first team to meet a specific goal (such as achieving a specific net income (such as $1,000,000) or the highest amount of net income within a certain period of time (such as one year) in sales of services/goods/production). The winning team may win a board member bonus upon meeting the specific goal.

Throughout the game, teams that meet specific goals or win specific mini-competitions will win various bonuses. For example, different competitions may be held between teams to win additional capital or other rewards (e.g., additional equipment, advertising, services such as advice from established businessmen/businesswomen, etc.).

In one embodiment of the invention, if the fixed capital and whatever additional generated capital won in competition is spend by the company, the game is over for that company. The company may still be in business (through the income generated from sales of the company's goods/services/etc.), but the company is no longer in the game.

When the game is over and a winning team is determined, the winning team will receive various prizes, such as a cash bonus, cars, and/or travel. The winning team may win business-specific prizes, such as new furniture, free rent on office space, and/or free advertising (which may occur on the television or web-based network that carried the game, and may even occur during the playing of one or more following games (e.g., the next seasons game) according to the invention game).

All teams, regardless of whether they win or lose, may have the ability to keep their companies after the game is over. The team members (who may also be the company owners) may have the right to do with the company as they wish, including selling, refinancing, dissolving, and continuing to run the company.

In one particular embodiment of the invention, there are 10 teams having 4 players (board members) each, and each player invests $50,000 into the game. A board member bonus of $600,000 is provided to the winning team.

In the above-discussed embodiments, each player provides the same player fee in the form of a dollar amount. However, in other embodiments, while each player is still expected to pay a player fee, the player fee does not necessarily have to be the same amount or be the same type of payment. For example, one or more players of a particular team may provide cash as their player fee; one or more players of that same team may provide expertise as their player fee; and one or more players of that same team may provide ideas (e.g., inventions) as their player fee.

In one embodiment of the invention, the game is a reality television series which connects ideas to capital, and which runs for a desired period of time (e.g., a television season or year). The show may be filmed around the contestants (i.e., players/board members) daily lives and their decisions they make with the companies. There can also be interaction with the public, such as via a game website which enables the public users (either free or for a fee, such as a website membership fee) to vote on decisions made by the players, and to offer advice on decisions to be made. Public users may be provided with rewards for their input. For example, one or more public users may be selected via a lottery-style selection to receive a reward, such as a cash payment. As another example, the public user who provides the most helpful information to assist a company (e.g., the winning team/company) may be provided with a cash prize or other reward. For example, the selected public user may be given the chance to be a team member (e.g., an investor) for an upcoming game/show, but without having to pay the full player fee. The public user who had provided the most useful information may be selected by the team which received that useful information (e.g., the winning team), by the controlling organization, or by public vote.

In one embodiment of a show according to the invention, each team consists of multiple investors who provide funding and general business expertise. Each team also includes one or more “contestants”, wherein the contestants are the individuals whose ideas/inventions were selected to as the business purpose of the team/company. (Note that for purposes of this application, the term “player” encompasses both investors and contestants.) The contestant(s) for each team may be selected by the investors of that team, which may include interviewing the various contestants (with the interviews broadcast as part of the show). Throughout the show, the investors and/or contestants may add narration to tell the story for each company and discuss the decisions (good or bad) which were made. A host may also be provided, with the host questioning the investors and contestants and also providing commentary throughout the game. In such an embodiment, the show includes players (in the form of investors and contestants), the teams/companies, the controlling organization, and the public (via public viewing and feedback).

The investors may be selected by the controlling organization and then formed into teams. For example, in one embodiment the investors are selected, and then the controlling organization assembles the investors into various teams. The selected investors may also be provided with the ability to fully or partially influence the assembly of the teams. For example, the controlling organization may select team captains, with the team captains then forming companies by selecting their team/company investors from among the pool of investors. Such selection could occur in a football-style draft style. As an alternative to the controlling organization selecting the investors, potential investors may form potential teams which are then marketed or otherwise presented to the controlling organization, and the controlling organization can select the final teams from among the potential teams/companies.

In one embodiment of the invention, potential contestants with company ideas may submit their ideas either online or in written format. The initial and final selections of potential contestants may be made by the controlling organization, the investors, and/or the public.

The products/services of the teams/companies will be depicted in the broadcast and/or website to see if the public is interested in using, purchasing, etc. the product/service, or if other interest is shown in the particular team/company. The broadcast and/or website will thus provide information to the public on how companies are created, designed, and run. The public will also be able to provide information (as feedback) as a consumer and consultant.

In one embodiment of the invention, there will be a central office in place to handle requests and otherwise coordinate with the teams and players/board members. The central office may have sub-contracts established with outside organization to provide goods and/or services needed to run each of the contestant companies. For example, these outside organizations may provide office supplies, computers, cell phones, sales, marketing, web services, patent or other legal services, logistics, communications, manufacturing, etc. Instead of having these outside organizations pay advertising fees or product placement fees, their goods/services will compensate for all or a portion of the amount of money they would otherwise have had to pay for such advertising/product placement. The participating teams/companies will have budgets to allow for some fees to be charged for the goods/services provided by the outside organizations, but the overall costs will be much less than a typical fee from these outside organizations. The outside organization sub-contracts are for the use of (but not limited to) marketing, advertising, publicity, web development, accounting, sales, production, logistics, storage, patents, trademarks, etc. This will allow for the players/board members to have their teams/companies run almost virtually but with the utmost quality in service and consulting.

In order to facilitate additional revenue and interest, the proposed game may also have an interactive functionality. The controlling organization may have an extensive website that will allow for outside viewers to interact by viewing developments of the participating teams and also by giving opinions and ideas to the participating teams. For example, there may be a voting feature to allow the fans to give their opinion of what company did the best job within one or more categories (some of these categories ideas will be (but not limited to) “best website”, “best marketing”, “best product/service”, “best advertisement”, etc). The voting feature may include a fee to be paid by the viewers who wish to vote. For example, a fee of $1.00 per vote cast may be charged to voting viewers, which could provide additional funds for the game as well as deterring vote fraud in the form of mass spam-like voting by one or a few people. The voters who choose the majority percentage correctly, to win a prize, such as $1,000, from a random drawing. At the conclusion of the game, or at various stages during the game, one or more teams (e.g., all teams, or at the end of the game the winning team) will also vote on which viewer gave or has given the most support and best idea(s) to assist the team in winning the game. The most supportive/best ideas/etc. viewer can be given a prize and/or the chance (via lottery or competition) to win a prize.

Depending on the particular embodiment, viewers may be able to view and/or interact with all areas of the website for free, or there may be a charge for a viewer to view and/or interact with one or more areas of the website (hereinafter “exclusive areas”). The ability to interact and/or view exclusive areas of the website may also be earned by a viewer through such actions as accessing the main page on a regular basis, by accessing outside sponsor websites via links on the game website, by providing feedback to one or more teams, etc. Individual teams can have the ability to grant one or more viewers access passes of various terms (e.g., one-time use passes, daily passes, “season” passes, etc.) which permit a viewer to access one or more of the exclusive areas of the website. For example, a team may be provided with a set number, such as 10, of full access season passes for the entire season/game which the team can give away as it sees fit. Each day of the game, the team may be granted a number of daily passes which are good only for that one day. Other pass terms (i.e., one-time, weekly, monthly, etc.) and access abilities (i.e., access to all exclusive areas, access to some exclusive areas, etc.) are also within the scope of the invention. This could be another revenue option.

Teams may be encouraged to draw web traffic to their individual websites. The team whose company website receives the most internet traffic on a particular day, during a week, during the entire game, or during other selected periods may win additional prizes.

There may be extensive advertising opportunities for sponsorship on this website. Links to all partners and advertisers may be used throughout the site. There may be keyword advertising used to facilitate any written updates on the companies used in order to additionally give a higher advertising value to assisting the controlling company's website.

The website may contain blogs, team web pages, voting polls, advertisements, revenue tracking, a partner's page, countdown to the finish, up to date news, etc. . . . some or all of which may be completely interactive for the viewer to be as involved as he/she wishes.

The team web pages may also be interactive with board member meetings on video, (which may be provided live via streaming web video), profiles of each team member (including pictures, background and video interview), team balance sheet, pertinent decisions made throughout their game process, budgets, marketing plans, sales plans, forecasts, mission statement, company logo and link to company webpage. Each participating company may also have a question and answer blog to communicate with the viewers if they so choose. Viewers may be able to critique decisions and offer advice if they so choose.

The television portion may be also used as ad revenue. The production company may create different stories from each of the characters in throughout the filming of the show. Many of these players and/or board members may live drastically different lives. Some of these players and/or board members may have full time jobs and are merely a player and/or board member because they submitted an idea. Some of these players may be retired and funding an idea they were able to view and invest in. A story of a mill worker pushing a time card of 60 hours per week may look extremely hard versus the life of a millionaire playing golf everyday and finishing it off with a nice dinner at the club.

The controlling organization/holding company will not be funding these companies, only assisting them to succeed at a level of publicity, marketing, advertising and servicing in a capacity very few small businesses will have an access to.

### BRIEF DESCRIPTION OF THE DRAWINGS

FIG. 1 depicts an organizational chart for a team according to an embodiment of the invention;

FIG. 2 depicts an organizational chart for a main game according to an embodiment of the invention;

FIG. 3 depicts a chart of revenue sources according to an embodiment of the invention;

FIGS. 4A and 4B depict different embodiments of main game (home) website page according to embodiments of the invention; and

FIG. 5 depicts an embodiment of a team home website page

### DETAILED DESCRIPTION

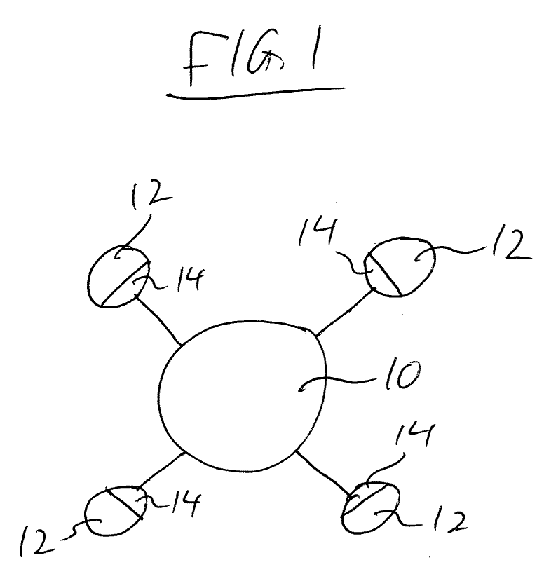

The invention is a game where different teams compete against each other. In the embodiment of FIG. 1, each team/company 10 is formed from a group of players 12 (e.g., four players) who wish to test an idea of a product, service, or good in competition with other teams/companies. Each player 12 provides an initial player fee 14 (e.g., $50,000 each) or other valuable asset toward their team/company's competing in the game. Each of these players 12 may be considered a “Board Member” for their team. These players/board members 12 may be given advanced communication equipment (such as a laptop and PDA to procure email, text messaging, video messaging and picture messaging within their teams via a virtual private network (vpn)) to make their game experience as simple or complex as they want it to be.

Each team/company 10 will additionally have a webpage provided through a controlling organization website detailing their company and their members. The Board Members 12 will be able to run their team/company 10 through communications provided by the controlling organization, thus enabling the Board Members 12 to live wherever they want, vacation wherever they want, etc. Board Members 12 will make all decisions regarding their team 10, in accordance with company by-laws which the Board Members 12 will have developed (with possible guidelines and limitations provided by the controlling organization) for their particular team/company 10. All companies 10 may be required to adhere to a high level of ethical and moral standards in order to compete. Each board will meet for quarterly meetings that will include itineraries which the Board Members 12 choose in order to enjoy their quarterly meeting while deciding on the best way to run their team/company 10.

Note that in embodiments where the players include (a) investors who provide money as their player fee, as well as (b) contestants who provide ideas/expertise as their player fee, not all of the players will necessarily be board members. For example, in one embodiment investors may be board members and thus have voting status in the operation of the company, while contestants who provided ideas may not have such voting status.

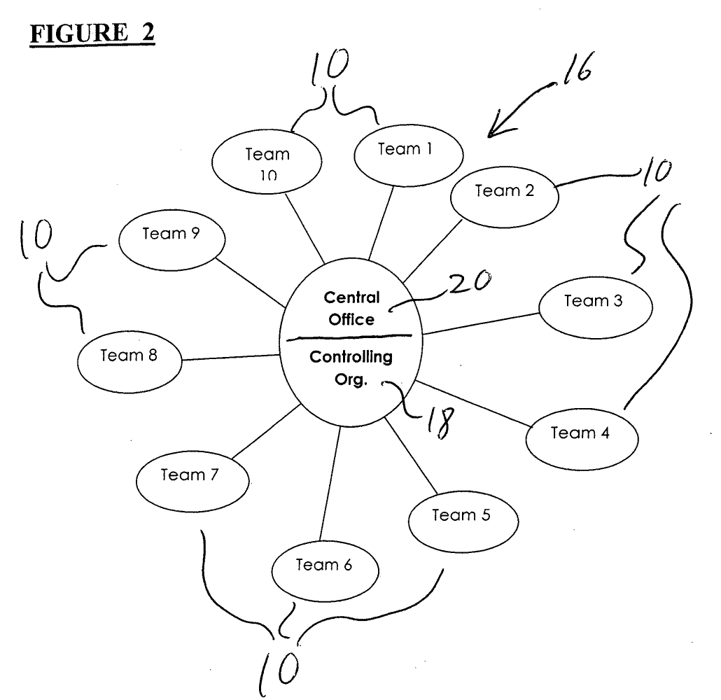

As depicted in FIG. 2, multiple teams 10 (e.g., ten teams) form a game 16, with the game 16 coordinated by a controlling organization 18 providing a Central Office 20. The central office 20 may consist of different services in order to operate each team 10 effectively. Some ideas of these services will be research, sales, marketing, advertising, business law, tax law, patent law, web development, etc. Note that the central office 20 may be a single physical location which provides services to all teams 10. The central office 20 may be physically co-located with one, all, none, or a portion of the teams 10. Alternatively, the central office 20 may be a “virtual” location from which services are provided to one or more of the teams 10. These services will be provided through independent contractor contracts from other successful vendors within these fields and will be paid through the operation budgets from the teams (e.g., $100,000 each). Once these budgets are used up, that's it. No more investing is allowed without forfeiting the game, in which case the forfeiting team is free to take their company with them. There will also be contracts pre-negotiated through different vendors for franchise opportunities for those who want to invest in those avenues. The central office may be a nice physical location where Board Members can meet and conduct business. The space for the central office will be rented until the game ends.

Setup Costs and Fees:

The initial investments of the Board Members are used to fund the company and game operating costs, as well as to fund the various prizes to be awarded throughout the game. In a 10-team situation with 4 investors per team (as discussed above), each investor/Board Member provides $50,000. With 40 total investors, the total provided is thus $2,000,000.

Each team is provided with an operational budget, such as $100,000. For ten teams, the total team operating costs per game are $1,000,000 (i.e., $100,000 per team with 10 teams).

Winning team receives a Board Member bonus of $600,000.

The remaining funds, e.g., $400,000 of the original $2,000,000 in the above example, are used to reimburse the Controlling Organization for costs, fees, etc. associated with conducting the game.

Note that the above-described embodiment is just one example of the invention. Other embodiments are also within the scope of the invention, including embodiments having different numbers of teams, different numbers of board members per team, different investment amounts per team, different budgets per team, different winning board member bonus amounts, etc. Also, teams may be selected for a particular game based on various factors, depending on the particular application. In one embodiment, teams may be selected based on their respective company product and/or services. For example, in one game the teams may all have products and/or services that are similar and/or directly (or indirectly) competitive. In one such embodiment, all teams in a particular game could have the goal of making a movie, with the teams which complete and makes the profit therefrom winning the game. In such an embodiment, teams can win prizes during the game by meeting specific goals, such as finishing the script, beginning filming, completing the movie, etc.

In a further embodiment, teams may be selected from groups that are already in unrelated competition. For example, each team may be selected from current students and/or alumni of a different college or university, with the game dedicated to a competition between various colleges or universities.

Some variations within the scope of the invention are as follows:

College Challenge: intended to be the next game in which Colleges and/or Universities within and outside of the United States compete to determine which school is producing the most successful students. The game will be similar in the way that it is run although there most likely will be an opportunity to host a much larger game.

Countries around the World Challenge: different countries around the world could compete in the greatest financial market.

Movie Challenge: green light and/or complete a fixed budget movie or other video feature, which could include various types of movies, including cartoons, commercials, short movies, adult-content movies, online videos, etc.

Television Show Challenge: develop a television game show.

Game Challenge: in which players create a specific game to fit with the general format of this invention.

Toys Challenge: Teams compete to design and market a new toy.

Website Challenge: Teams compete to design and develop the most-visited website.

Video Game Challenge: Teams compete to design and develop the best video game.

Note that the above are just some examples of embodiments of the invention.

The “Web-Reality” or “Television Reality” Portion of the Controlling Organization:

In order to facilitate additional revenue and interest, the proposed game will also have an interactive functionality. The controlling organization will have an extensive website that will allow for outside viewers to interact by viewing developments of the participating teams and also by giving opinions and ideas to the participating teams. For example, there will be a voting feature to allow the fans to give their opinion of what company did the best job within one or more categories (some of these categories ideas will be (but not limited to) “best website”, “best marketing”, “best product/service”, “best advertisement”, etc). The voting feature may include a fee to be paid by the viewers who wish to vote. For example, a fee of $1.00 per vote cast may be charged to voting viewers, which could provide additional funds for the game as well as deterring vote fraud in the form of mass spam-like voting by one or a few people. The voters who choose the winning team correctly (in the overall team competition and/or in any of the team challenges or other team competitions) will have the opportunity to win a prize, such as $1,000, from a random drawing. At the conclusion of the game, or at various stages during the game, one or more teams (e.g., all teams, or at the end of the game the winning team) will also vote on which viewer gave or has given the most support and best idea(s) to assist the team in winning the game. The most supportive/best ideas/etc. viewer can be given a prize and/or the chance (via lottery or competition) to win a prize.

Depending on the particular embodiment, viewers may be able to view and/or interact with all areas of the website for free, or there may be a charge for a viewer to view and/or interact with one or more areas of the website (hereinafter “exclusive areas”). The ability to interact and/or view exclusive areas of the website may also be earned by a viewer through such actions as accessing the main page on a regular basis, by accessing outside sponsor websites via links on the game website, by providing feedback to one or more teams, etc. Individual teams can have the ability to grant one or more viewers access passes of various terms (e.g., one-time use passes, daily passes, “season” passes, etc.) which permit a viewer to access one or more of the exclusive areas of the website. For example, a team may be provided with a set number, such as 10, of full access season passes for the entire season/game which the team can give away as it sees fit. Each day of the game, the team may be granted a number of daily passes which are good only for that one day. Other pass terms (i.e., one-time, weekly, monthly, etc.) and access abilities (i.e., access to all exclusive areas, access to some exclusive areas, etc.) are also within the scope of the invention.

Teams may be encouraged to draw web traffic to their individual websites. The team whose company website receives the most internet traffic on a particular day, during a week, during the entire game, or during other selected periods may win additional prizes.

There will be extensive advertising opportunities for sponsorship on this website. Links to all partners and advertisers will be used throughout the site. There will be keyword advertising used to facilitate any written updates on the companies used in order to additionally give a higher advertising value to assisting the controlling company's website.

The website will contain blogs, team web pages, voting polls, advertisements, revenue tracking, a partner's page, countdown to the finish, up to date news, etc.—completely interactive for the viewer to be as involved as he/she wishes.

The team web pages will also be interactive with board member meetings on video, (which may be provided live via streaming web video), profiles of each team member (including pictures, background and video interview), team balance sheet, pertinent decisions made throughout their game process, budgets, marketing plans, sales plans, forecasts, mission statement, company logo and link to company webpage. Each participating company will also have a question and answer blog to communicate with the viewers if they so choose. Viewers will be able to critique decisions and offer advice if they so choose.

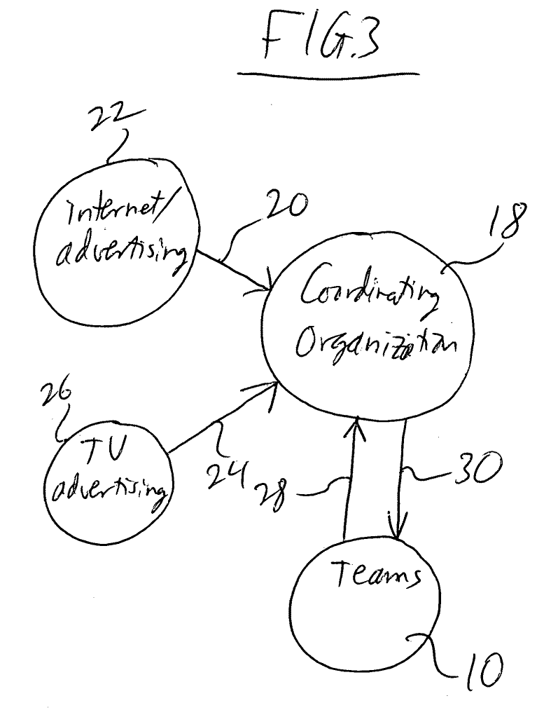

FIG. 3 depicts an example of the various revenue streams of one embodiment of the invention, including revenue created from a website and a television show as well as investments made by the teams. The controlling organization 18 holds the revenue/payments, including revenue 20 from internet advertising/web-reality 22, revenue 24 from TV advertising 26, team investments 28, etc. The controlling organization 18 also provides budget funds 30 to each team 10. Note that income generated by each team/company, in this embodiment, is not part of the revenue stream of the game, but instead is provided to each company/team. However, depending on the particular embodiment, the controlling organization 18 may control, oversee, and/or otherwise monitor/audit the income of each team in order to determine and verify which team has the greatest net income at the end of the game from the various teams

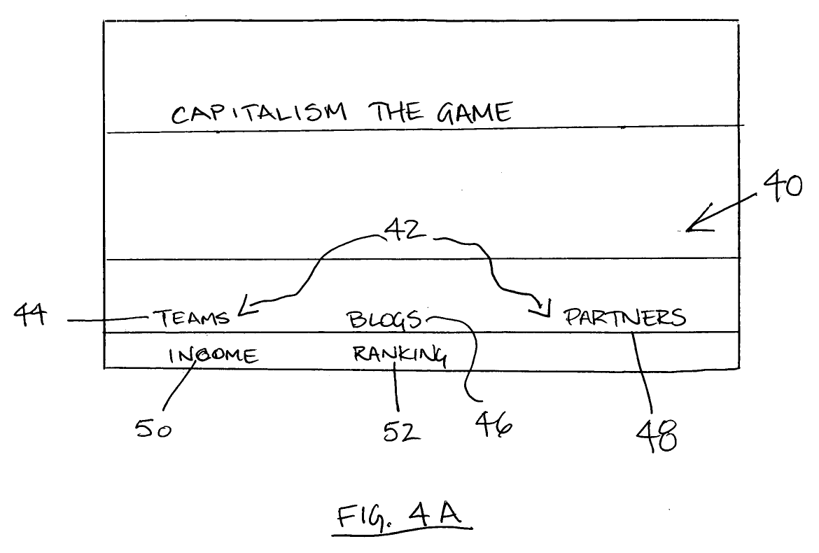

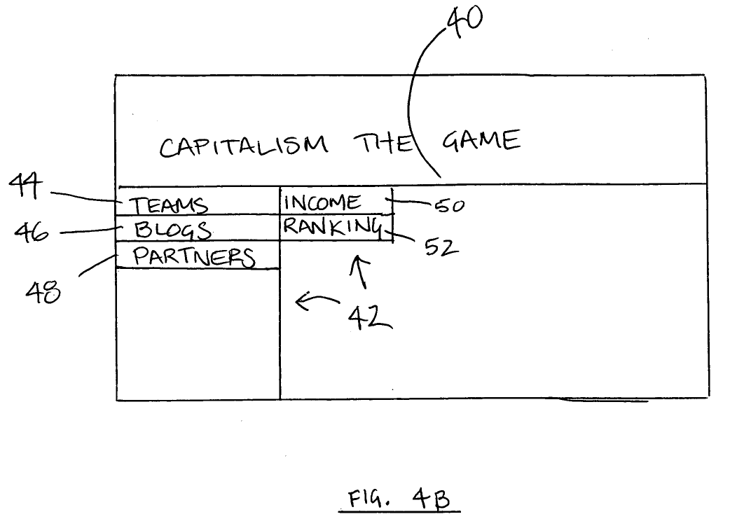

FIGS. 4A and 4B depict different examples of a main (home) page 40 for the game according to an embodiment of the invention. The main page 40 includes various links 42, including a team pages link 44, blogs link 46, partners link 48, (e.g., sponsor links/advertisements), etc. Note that there can be specific links to list respective team incomes 50 and ranking 52.

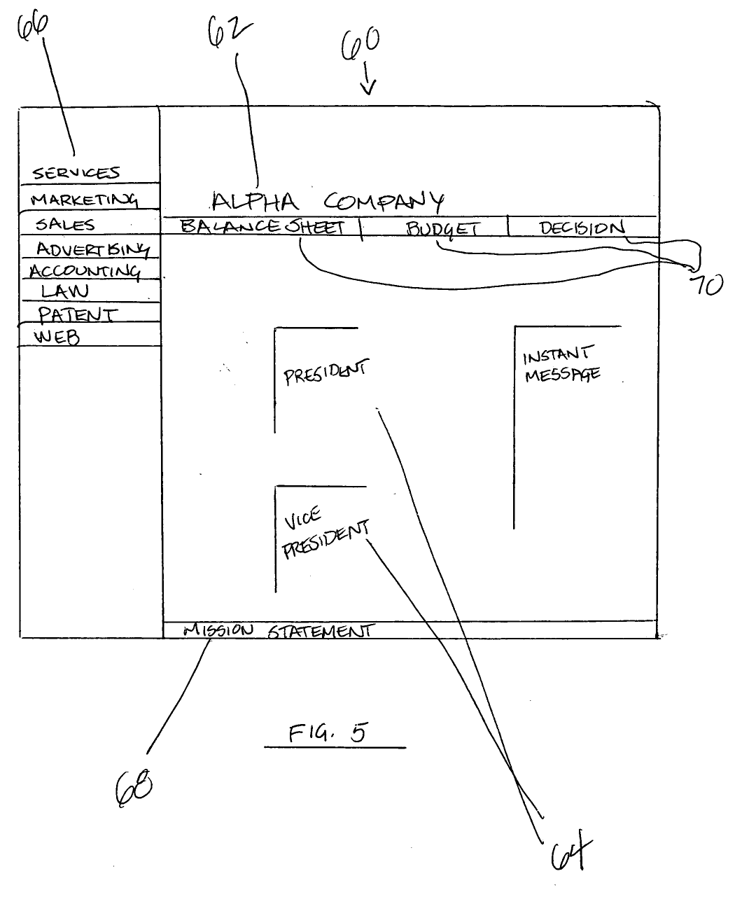

FIG. 5 depicts an example of a team home page 60. The team home page 60 includes information about the team (which can be provided in link, pop-up, etc. form) such as team name 62, board member names/bios 64, team goal 66 (e.g., product/service to be provided), mission statement 68, financial status 70, etc. Depending on the particular application, each team may have complete freedom in designing its home page 60, or may have some limits on the information and/presentation style of their home page 60.

While the invention has been described with reference to particular embodiments, it will be understood that various changes and additional variations may be made, and equivalents may be substituted for elements thereof, without departing from the scope of the invention or the inventive concept thereof. In addition, many modifications may be made to adapt a particular situation or device to the teachings of the invention without departing from the essential scope thereof. Therefore, it is intended that the invention not be limited to the particular embodiments disclosed herein, but that the invention will include all embodiments falling within the scope of the appended claims.

What is claimed is:

1. A method of playing a game, and presenting one or more portions of the game over a broadcast system, said method comprising:
a) providing multiple teams, wherein each team has multiple players, each player provides a player fee to the team, and each team has a business plan intended to generate income for the team;
b) providing a controlling organization, wherein each team provides a team fee to the controlling organization, and the controlling organization provides funding and services to each team;
c) playing a game round in which each team attempts to generate income for that team;
d) evaluating the results of said game round to determine which team has generated the most income; and
e) presenting portions of steps (c) and (d) over a broadcast system.

2. The method of claim 1, wherein the broadcast system is a television network.

3. The method of claim 1, wherein the broadcast system is an internet-based network.

4. The method of claim 1, further comprising:
f) providing a game website, wherein the game website is configured to provide team information to outside users, and also to provide users the opportunity to provide feedback to the controlling organization.

5. The method of claim 4, wherein the game website is configured to provide users the opportunity to provide feedback to one or more teams.

6. A system substantially as described and depicted.

7. A method substantially as described and depicted.

8. An apparatus substantially as described and depicted.
